(19) United States
(12) Patent Application Publication
(10) Pub. No.: US 2008/0143875 A1
(43) Pub. Date: Jun. 19, 2008

(54) METHOD AND SYSTEM FOR SYNCHRONOUS VIDEO CAPTURE AND OUTPUT

(76) Inventors: Stacey L. Scott, Roswell, GA (US); Yaroslav Olegovich Shirokov, Alpharetta, GA (US); Sean Ashley Bryant, Mableton, GA (US); James A. Holmes, Roswell, GA (US)

Correspondence Address: POWELL GOLDSTEIN LLP, ONE ATLANTIC CENTER FOURTEENTH FLOOR, 1201 WEST PEACHTREE STREET NW, ATLANTA, GA, 30309-3488, US

(21) Appl. No.: 11/839,930

(22) Filed: Aug. 16, 2007

Related U.S. Application Data
(60) Provisional application No. 60/822,733, filed on Aug. 17, 2006.

(51) Int. Cl. H04N 9/475

(52) U.S. Cl. 348/512; 348/E09.034

(57) ABSTRACT

A method and system for processing a plurality of digital video data streams is provided. A plurality of digital video data streams are captured at a plurality of nodes. Each digital video data stream comprises a plurality of video clips and includes data identifying the content of each of said video clips in the data stream. Video clips from at least two of the plurality of digital video data streams can be synchronized to create a single synchronized video data stream that includes synchronized content from the video clips. The resulting synchronized video data stream can be extracted and output to an output medium for delivery to a consumer.

### CROSS-REFERENCE TO RELATED APPLICATION

This application claims benefit of U.S. Provisional Application No. 60/822,733 filed on Aug. 17, 2006, which is hereby incorporated by reference herein in its entirety.

### FIELD

Aspects and features described herein relate to a method and system for use in video processing, more particularly to processing a plurality of video streams to produce a plurality of synchronized video clips for output to a consumer on a storage medium such as a CD.

### BACKGROUND

The use of video has become commonplace, and digital-format video is fast becoming the standard, as it allows users to easily store and transfer content between media such as home computers and personal web pages or to add effects and captioning to make the video truly personal. In addition, digital-format video can allow a user to stop the moving action at any moment and extract the content to a still image file such as a JPEG or a BMP, thus easily creating a photograph from the video.

The Moving Picture Experts Group (MPEG) has developed a set of standards for encoding and compressing digital media files. For example, MPEG-2 comprises a set of audio and video standards used for broadcast-quality television. MPEG-2 transport stream (MPEG-2 TS) is a communications protocol used for audio, video, and data that can allow for multiplexing and synchronization of digital audio and video output. MPEG-4 provides a compression standard for digital audio and video data, and is most often used in providing compressed video for use in web streaming media transmissions, broadcast television, and transfer of the digital content to CD.

Video processing has been described in a number of U.S. patents and published applications. For example, U.S. Pat. No. 6,813,745 to Duncome describes a media system including means for storing a media file and a media organization file, wherein the media organization file includes a defining means for defining media selection parameters having a plurality of media descriptions. The media organization file also has a database for associating the media clips with the media descriptions. A goal of the invention of the '745 patent is to provide a media system so that a user can use a search engine to create custom media presentations.

U.S. Pat. No. 6,952,804 to Kumagai et al. describes a video supply device and method that allows storage of a first version of the video and a second, different, version of the video and that allows extraction of a portion of one of the first and second videos for editing.

U.S. Pat. No. 6,954,894 to Balnaves et al. describes a method for production of multi-media input data comprising inputting one or more multi-media input data sets, inputting one or more templates and applying the templates to the input data sets to produce a processed output data set for storage, display, and/or further processing.

U.S. Patent Application Publication No. 2002/0070958 to Yeo et al. describes a method of generating a visual program summary in which a computing device continuously captures frames from a set of available video feeds such as television channels, analyzes the captured video frames to remove redundant frames, and then selects a set of frames for a visual program summary. The selected frames are then composited together to generate a visual program summary.

U.S. Patent Application Publication No. 2003/0234803 to Toyama et al. describes a system and method for generating shorts segments of video, described as “cliplets,” from a larger video source. The length of the cliplet is predetermined prior to its generation and the cliplet ideally contains a single short event or theme.

U.S. Patent Application Publication No. 2004/0189688 to Miller et al. describes a method and system for processing media content involving an editing project having one or more track, each of which is associated with one or more data stream sources that can have effects or transitions applied on them.

U.S. Patent Application Publication No. 2006/0064716 to Sull et al. describes techniques for use of thumbnail images to navigate for potential selection between a plurality of images or video files or video segments.

U.S. Patent Application Publication No. 2006/0187342 to Soupliotis describes an automatic video enhancement system and method which uses frame-to-frame motion estimation as the basis of the video enhancement. The motion estimation generates and uses global alignment transforms and optic flow vectors to enhance the video. Video processing and enhancement techniques are described, including a deinterlace process, a denoise process, and a warp stabilization process using frame to frame motion estimation.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter.

Aspects and features described herein relate to a method and system for more efficiently processing audio and video data to reduce the period between the time a video is recorded using a video camera and the time a finished product is delivered to the customer. A process in accordance with aspects herein involves a plurality of nodes, each node being capable of receiving and sending messages and data to one or more other nodes. Using messaging and/or data transfer between nodes, a digital video file, for example, a video stream from an MPEG-2 TS compatible camera, can be recorded, captured, rendered, processed, and output to a consumer format. In addition, in accordance with aspects herein, one or more digital video files can be combined and processed to provide a single video output permitting multiple views, so that a user can, for example, see the same event from multiple angles in order to get a more favorable view of the action. It should be noted that although the following description uses the term “digital video” or “video” one skilled in the art would understand that the video can also include audio that is recorded along with the video file.

### BRIEF DESCRIPTION OF THE DRAWINGS

FIG. 1 depicts various nodes of an embodiment of a distributed video production system according to one or more aspects described herein.

FIGS. 2A-2E contain block diagrams depicting exemplary steps used for synchronized capture of data from multiple video cameras in accordance with one or more aspects described herein.

FIG. 3 depicts an exemplary information flow for capturing data from N cameras with automatic data pooling to a centralized repository.

FIGS. 4A-4B depict a data flow in capture and render nodes for automatic synchronization of multiple video streams to a single frame in accordance with one or more aspects described herein.

### DETAILED DESCRIPTION

The aspects and features summarized above can be embodied in various forms. The following description shows, by way of illustration, combinations and configurations in which the aspects can be practiced. It should be understood that the described aspects and/or embodiments are merely examples and that other aspects and/or embodiments can be utilized. It should further be understood that structural and functional modifications of the aspects, features, and embodiments described herein can be made without departing from the scope of the present disclosure. For example, although aspects and features herein are described in the context of use of an MPEG-2 TS compatible camera to capture a digital video stream to a storage device, other digital video formats and devices can also be utilized within the scope and spirit of the embodiments described herein.

Aspects and features described herein comprise a distributed video production system that is capable of simultaneously capturing at least one stream of video to a digital storage medium, wherein the stream is processed into smaller video clips that can be exported to a consumer-ready video format and distributed to the consumer on a portable medium, such as a CD. In an embodiment in accordance with aspects and features herein, multiple streams of high definition non-interlaced video from multiple MPEG-2 TS compatible cameras can be captured onto a digital storage medium. In accordance aspects and features described herein, a user can easily search through the recorded MPEG-2 TS file and identify and mark portions of interest. These captured video digital files can then be synchronized, for example, into a single video frame, and the synchronized captured video processed and sliced into smaller video clips. These video clips are then burned to a Compact Disc in MPEG-4 format, maintaining their original synchronization. A method and system as described above can allow viewing of the recorded video clips by a user and can allow manipulation between the synchronized multiple video clips in real time.

In accordance with aspects and features described herein, the user can advance or retard the video image on a frame-by-frame basis as desired to select a particular portion of the recorded images. The use of non-interlaced video means that each video frame is a full image of the action in that frame. The use of non-interlaced video also allows the avoidance of data artifacts and other distortions inherent in the processing of interlaced video into individual images. In accordance with aspects and features herein, once the user has identified a video frame having the desired content, the frame may be captured as a print-quality JPEG image for a still picture. Alternatively, the user can select a sequence of frames to provide a smaller video clip which can be, for example, e-mailed to friends and family or uploaded to the web.

In addition, the use of multiple cameras means the action may be viewed from each camera angle, and the most desirable viewing direction selected. The best mage from each camera for different scenes of interest, or from various times within the same scene, can be readily selected and used by the user. The user can then readily compile a video which can change dynamically between the best images from each camera when the video is viewed.

An exemplary use of a method and system in accordance with aspects described herein will now be described. In this example, video of a gymnastics event can be captured by two cameras, each aimed at a different angle so that a different view is given by each. During the course of the event video of ten participants is captured by each camera. Using a system in accordance with aspects and features described herein, capture of video from the two cameras is synchronized so that the two video streams are captured substantially simultaneously. The captured video from each camera is then transferred to a video manager which creates an index of the information on each video, for example, by identifying where on each video file the video for each participant is located. Then, a video editing tool can request the portion of each video file on which a desired participant appears, and a rendering tool can extract that portion of the video from each file. Finally, the video can be converted to a consumer-readable format and burned to an output medium such as a CD. The end product is a customized video containing the desired portion of the video stream depicting the gymnastic activities of one or more participants. In addition, because multiple cameras are used to create a synchronized multi-angle video stream, the user can easily switch between the views of each camera to get the best view of the action.

In addition, in accordance with aspects and features described herein, a user can view the video from the final product, for example, on a computer having a CD drive. In accordance with aspects herein, the video on the CD can be in a compressed video format such as MPEG-4 format known in the art. As is known in the art, MPEG-4 utilizes intravideo frames (I-frames), predictive frames (P-frames), and bi-directional predictive frames (B-frames) to create a video stream. In accordance with aspects herein, while viewing the video on a computer, a user can move through the various video scenes with a cursor, in a process known as “scrubbing” the video. During scrubbing, each I-frame of the video is decoded for view at a reduced resolution while the user is actively moving through the video. For example, using current standards, a full-resolution I-frame is at least 1280×720 pixels. In the present system, each I-frame can be broken down into 8×8 pixel blocks, making a grid of 160×90 blocks. The pixels of each block are more rapidly processed than would be the case if the system had to operate on each individual pixel, allowing the user to decode more frames as the user scrubs through the video, which results in a smooth, non-jerky display of the successive video frames.

In addition, in accordance with aspects herein, when the cursor is stopped at a particular point in the video, the I-frame at that point is decoded at full resolution. At that point, the user can move forward or backward within the video with each I-frame at full resolution by using a simple “frame forward” or “frame back” command. Also, as described above, the user can switch between views from the various cameras used to create the video to find the view that is most desired. In this way, when the desired view is found, a “freeze-frame” picture of a single frame can easily be selected, printed, and/or saved. For example, based on current standards, a full-resolution I-frame picture is at least 1280×720 pixels (or 0.9 megapixels), which can be readily printed as a 4×6 or 5×7 picture, or saved as a digital file to be e-mailed or uploaded to a web page. More or less resolution can be achieved depending on the limitations of the camera used, and it can be expected that resolution levels will improve as camera technology advances.

All of the functions above may be executed through an intuitive graphical user interface requiring a minimum of user training, and may be rapidly accomplished at the video capture location, and shortly after the video has been captured.

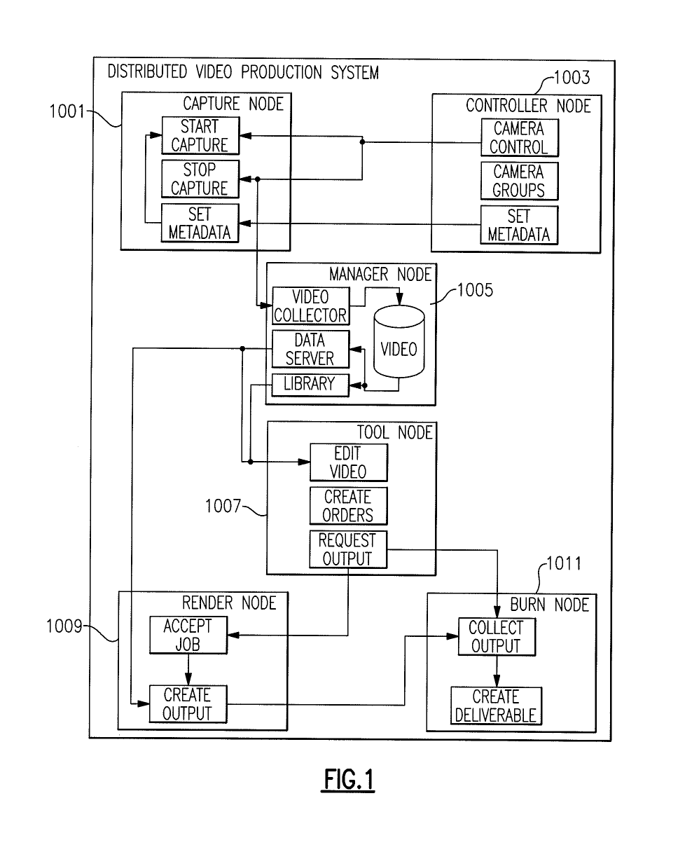

The above-described functions can be accomplished by a network system comprising a plurality of nodes, for example, as depicted in the exemplary configuration shown in FIG. 1.

An exemplary system according to aspects described herein comprises a Capture node 1001, Controller node 1003, Manager node 1005, Tool node 1007, Render node 1009, and Burn node 1011. Processing of one or more video files by a system as described herein can be accomplished by means of messaging between two or more of these nodes. Information regarding exemplary messaging that can be used between nodes in accordance with one or more aspects herein can be found in the it'sMEdia Suite Design Specifications document that is attached as Exhibit A hereto and is hereby incorporated by reference herein as to its entire contents. In accordance with one or more aspects herein, there can be up to 16 of each type of node running on one physical machine or bound to one particular IP address, although in practice usually no more than four of each type of node to be running on any particular machine.

At Capture node 1001, one or more video images, such as high definition non-interlaced video from an MPEG-2 TS compatible camera, can be captured and stored onto a digital data storage medium, such as a hard drive on a computer linked to the video camera. According to one or more aspects described herein, there is a one-to-one relationship between each capture node and each camera. In addition, each capture node requires a high-speed, high-volume data transfer means between the camera and the data storage medium. At present, such high-speed data transfer is ordinarily accomplished by means of an IEEE 1394 FireWire port, although it is contemplated that other data transfer ports may be suitable so long as they can perform such high-speed data transfer from the camera to the data storage medium serving as the capture node.

In accordance with one or more aspects described herein, Capture node 1001 can perform its functions under the direction of a Controller node 1003. As described in more detail below, capture and synchronization of multiple video streams at Capture node 1001 can be controlled by a camera control in Controller node 1003, which can set and control one or more camera groups for which synchronized capture is desired. In accordance with aspects and features herein, a metadata file for the captured MPEG-2 TS video stream can be created when capture is initiated. This metadata file can include information relating to the video such as date, time, event, participants, or other information. An index file also can be created when capture is initiated, and can include information to enable a video tool to decode and encode the MPEG-2 TS video stream for the purpose of viewing and editing the stream.

Once the video files have been captured by Capture node 1001 under the control of Controller node 1003, as seen in FIG. 1, Manager node 1005 can act to coordinate the transfer of data across the network to the other nodes. Manager node 1005 can reside either on a computer that also functions as a capture device for one of the video cameras or on a separate central computer. Although each computer in the network can serve as a Manager, at any one time, there can be only one Manager node in each network. Which computer in the network will act as a manager at any one time can be determined by software, for example, based on an IP address.

In accordance with one or more aspects and features described herein, a Manager node 1005 also can include software that can move the various MPEG-2 TS video files from the one or more capture devices and create a library of the video files for use in further processing. As seen in FIG. 1, Manager node 1005 can include a video collector that can move the video files from the various Capture nodes 1001 and transfer them to a central video repository. Once all of the video files have been gathered, using the index file that was created by Controller node 1003 during capture, Manager node 1005 can identify a portion of the video file in the library that contains the desired video to be rendered at Tool node 1007 for each customer. This transfer can occur automatically, under the direction of software, without human intervention. It should be noted, however, that creation of the central library of video files from the various Capture nodes is not required and that processing can be done on by the video tool directly on the video files from the Capture nodes.

Tool node 1007 seen in FIG. 1 can receive the video stream from Manager node 1005, either directly from a data server in the Manager node or from a library of video clips. Tool node 1007 can view and edit the video stream to create an order to be rendered, i.e., extracted by Render node 1009. In accordance with aspects and features described herein, Tool node 1007 acts directly on the original video stream, for example, the original MPEG-2 TS video stream, and does not create an intermediary file as in the prior art. Instead, Tool node 1007 reads, decodes, and edits the raw MPEG-2 TS video stream without the need for creation of an intermediary file for editing.

Render node 1009 can extract the desired portion of the video stream and convert it to a consumer-deliverable format, such as MPEG-4 video. As seen in FIG. 1, Render node can accept an order from Tool node 1007 and can create the desired output file to be burned to an output medium at Burn node 1011.

Finally, Burn node 1011 can burn the rendered video clips to an output medium such as a CD, DVD, or a hard disk drive. Note that as seen in FIG. 1, Burn node 1011 can receive orders to create output either from Render node 1009 or directly from Tool node 1007 to create the deliverable output for the user.

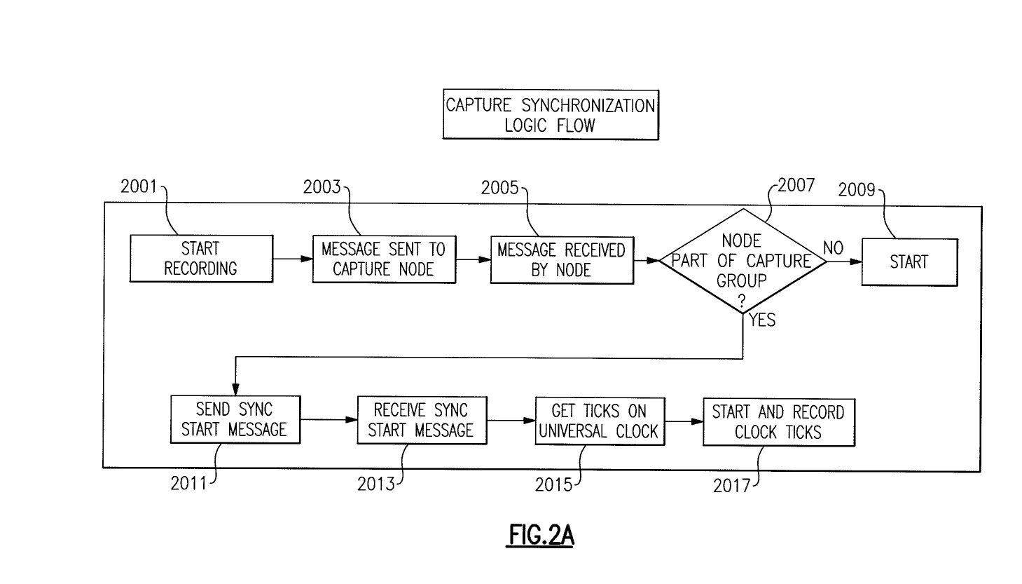

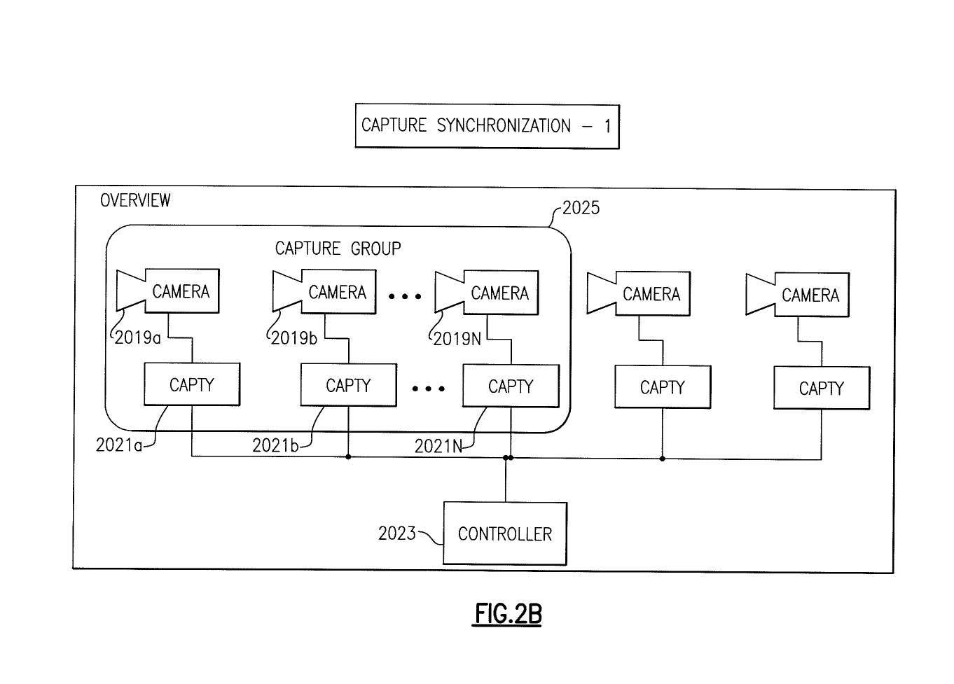

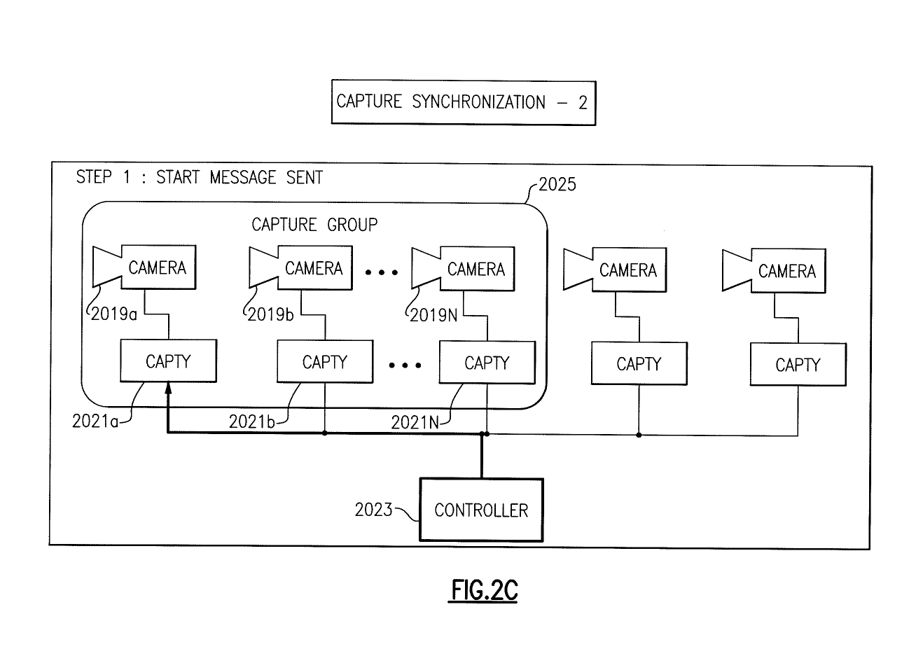

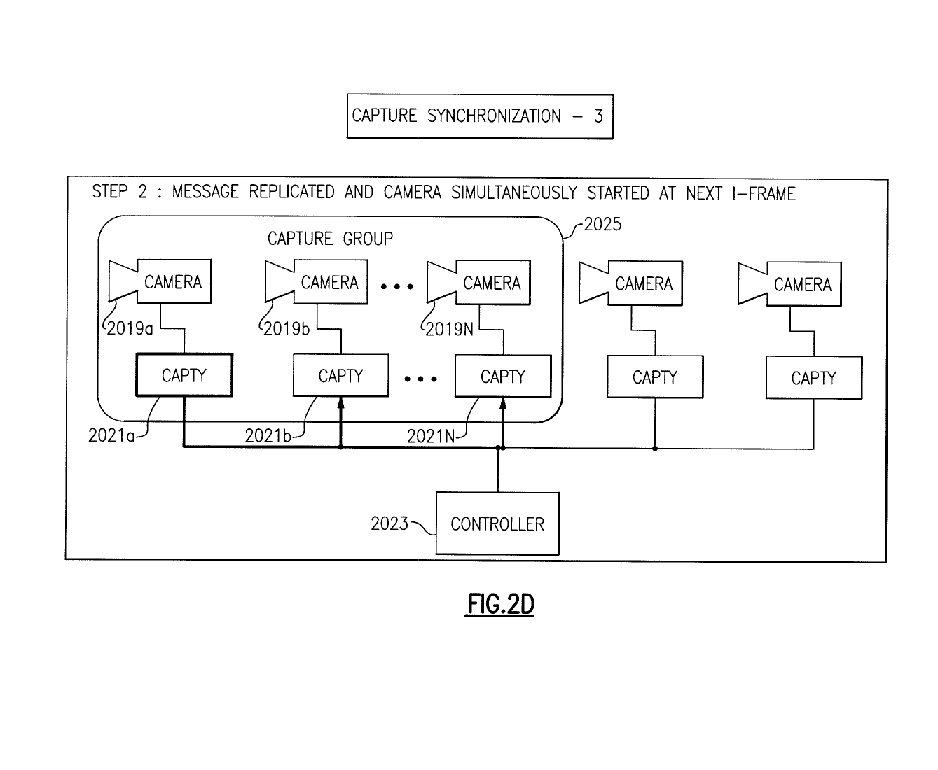

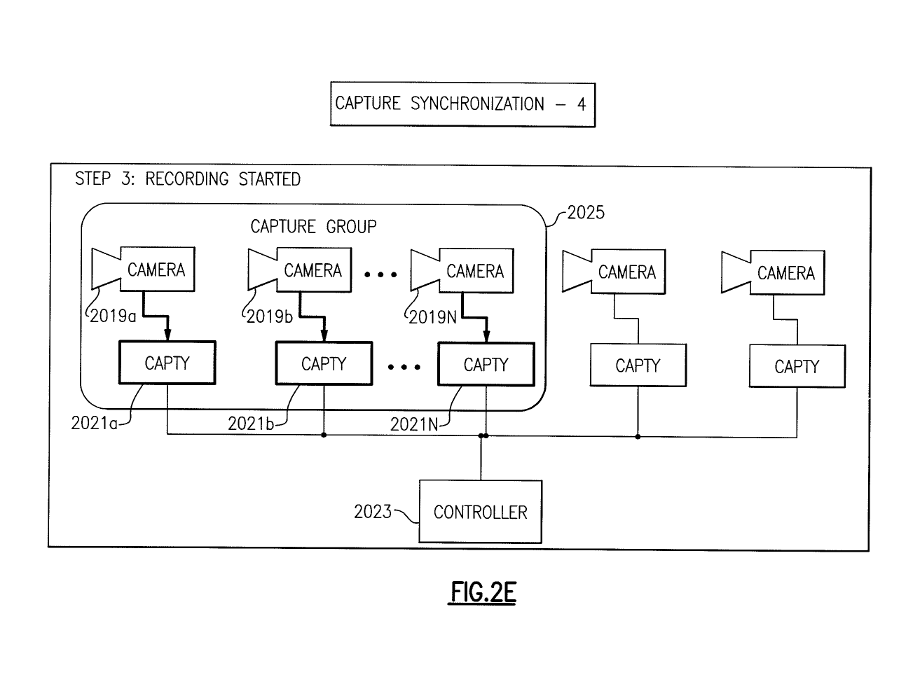

FIGS. 2A-2E depict exemplary steps that can be used in synchronizing a plurality of video cameras at one or more Capture nodes in accordance with aspects herein.

FIG. 2A depicts a logic flow that can be used in capture synchronization in accordance with aspects and features described herein. At step 2001, the camera, for example, an MEPG-2 TS compatible camera as described earlier herein, can start capturing an event, for example, upon receipt of a command from a controller such as a controller at Controller node 1003 described above. At step 2003, a message that the camera has begun capturing the MPEG-2 TS video stream can be sent to a capture node such as Capture node 1001 described above, and at step 2005, the message is received by the capture node. As noted above, each camera has a unique capture node associated with it. At step 2007, software in the controller determines whether the capture node for that particular camera is part of a desired capture group for that particular capture session. If the answer at step 2007, is “no,” the logic flow proceeds at step 2009 to “start” and the camera awaits the next cycle of synchronization. On the other hand, if the answer at step 2007 is “yes,” at step 2011, the controls can send a “sync start” message to the capture node for that camera so that the capture can be synchronized with other cameras in the capture group. At step 2013, a processor at the capture node receives the sync start message, and at step 2015, the controller for that camera gets ticks on a universal clock that is shared by all cameras in the capture group. Finally, at step 2017, the capture node will begin storing the video stream being captured by its associated camera, along with the clock ticks so that the video captured from camera in the capture group can be identified and synchronized using the universal clock ticks.

FIGS. 2B-2E depict steps in the messaging flow used to capture synchronized video from a plurality of cameras in accordance with one or more aspects herein. As shown in FIG. 2B, capture synchronization involves a relationship between controller 2023, the cameras 2019a-2019N in the capture group and the “capty” capture node devices 2021a-2021N associated with each camera.

As shown in FIG. 2C, capture synchronization begins when controller 2023 sends a “capture” message to camera 2019a via capty device 2021a. In accordance with aspects herein, if the capture node, for example, Capture node 1001 shown in FIG. 1, is not linked to any other capture nodes in the network, the “capture” command from controller 2023 can open the appropriate files in the capture node and set the capturing status for the capture node's associated camera to “busy.” If the capture node for a camera is linked to other capture nodes in the network, for example in capture group 2025 shown in FIG. 2B, Controller 2023 can send a “syncstart” message to one of the linked cameras 2019a by means of its associated capty capture node device to begin synchronized capturing by all cameras 2019a-2019N in capture group 2025.

As shown in FIG. 2D, when the “syncstart” message is received by a first capty device 2021a, the message is then replicated by that capty device and passed on to the next capty device 2021N in capture group 2025 so that its associated camera can begin synchronized capturing at the next I-frame, i.e., at the next frame of digital content.

As seen in FIG. 2E, once the “syncstart” message has been passed to all capty devices 2021a-2021N in capture group 2025, the cameras 2019a-2021N in capture group 2025 can begin capturing and transferring their video streams to their respective capty capture node devices. In accordance with these and other aspects described in more detail herein, these multiple video streams can be synchronized automatically to within 1/30 to ⅕ of a second.

When the desired capture has been made, a “stop capturing” message can be sent from controller 2023 to one or more of the capty devices to stop capturing the video stream. If a camera is not linked to other cameras in a capture group, the receipt of a “stop capturing” message from controller 2023, the capty capture node for that camera should close all open files and reset its capture status to “ready” so that it can be ready to accept a new command from controller 2023 If the camera is a linked camera as part of a capture group 2025, the message from controller 2023 to a first capty capture node can be broadcast by that capty to all other capty capture nodes in the capture group as a “syncstop” message to cause all the linked cameras to stop capturing substantially simultaneously.

As described above, if the cameras 2019a-2019N are linked as part of a capture group, a “syncstart” message will signal the respective associated capty capture nodes 2021a-2021N to start capturing the camera's output simultaneously with the other capty nodes in the group. In addition, upon receipt of a “syncstart” message, each capty capture node can note the filename for the capture being made and can notify each of the other capty capture nodes of this filename, for example, using a unique “synckey” message. A “syncid” tag can be used to describe a unique key for the current linked capture session, and can be used to coordinate the collection of the various unique identifiers from each of the linked capty capture nodes. In accordance with aspects herein, upon receipt of a “syncstart” message, all linked capty capture nodes can broadcast an announcement to the other capty capture nodes in the capture group containing a unique identification number (UID), identified, for example, by the synckey. Any other capty capture node in the capture group that receives this message can store the linked UID in its local memory so that all captured files having the same UID can easily be associated.

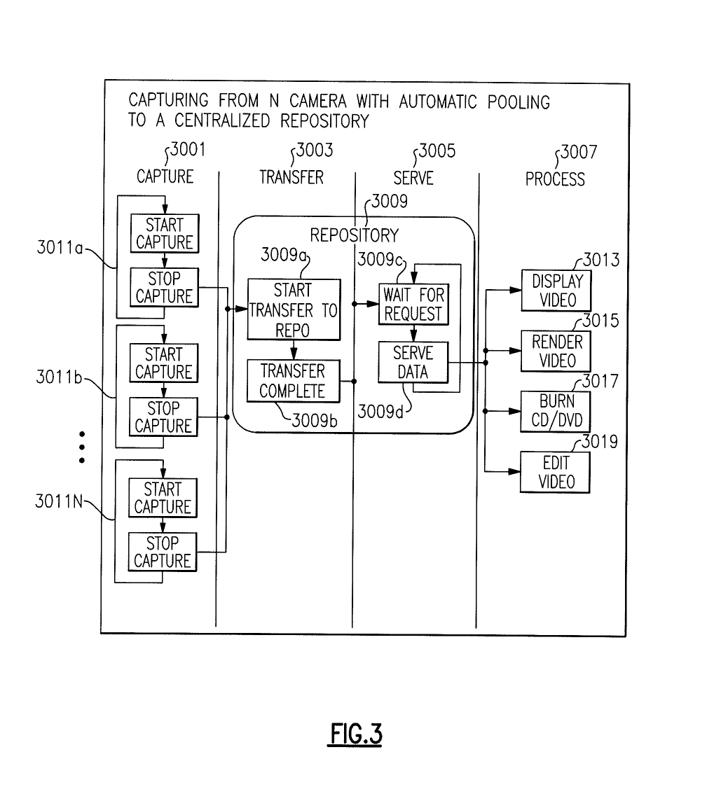

FIG. 3 depicts additional aspects regarding capture of multiple video streams as described herein. As seen in FIG. 3, captured video streams from N cameras can automatically be pooled to a central repository before being processed for output to a consumer. As seen in FIG. 3, this process involves a capture phase 3001, a transfer phase 3003, a serve phase 3005, and a process phase 3007. Capture phase 3001 occurs at one or more capture nodes 3011a-3011N wherein each capture node comprises a start capture/stop capture loop. In accordance with one or more aspects described herein, when a stop message is received by a capture node, the capture node can transfer its data to a central repository. One way in which this can be accomplished is by messaging between the capture node and the manager node, wherein the capture node can request a “transfer token” from the manager node. Upon receipt of the transfer token from the manager, the capture node can copy all of the captured video files from memory in the computer housing the capture node to a central memory. Once the video files are transferred, the capture node can release the transfer token back to the manager so that it can be used by the next requesting capture node.

Thus, as seen in FIG. 3, at step 3009a the transfer of all captured video from the 3011N capture node to repository 3009 can begin and at step 3009b the transfer is complete. When the transfer is complete, the captured video remains in the repository and at step 3009c waits for a request to serve the data 3009d. Once the data is served, the next transferred stream of data is transferred to the repository where it awaits the next data request. In accordance with aspects herein, the video stream is processed in near-real time as it is captured from the various cameras. Unlike the prior art which requires the creation of an intermediary file used for editing, the present invention reads, decodes, and edits the MPEG-2 transport stream directly, without the creation of an intermediary file.

Upon receipt of a request from the processing stage 3007, the data can be served at step 3009d to, for example, video tool node 1007 described above with reference to FIG. 1. At the processing stage, the video can be displayed at step 3013, for example, so that the appropriate frames containing the desired portion of the video stream can be selected. Once the desired portion of the video stream has been selected, at step 3015, that portion of the video stream can be rendered, i.e., extracted and converted to a consumer-readable format such as MPEG-4 video and burned to an output medium such as a CD/DVD at step 3017. Finally, at step 3019, the completed video can be edited by the consumer on his or her home computer to extract an image for printing as a photograph, to add additional metadata, captioning, or other material using standard video editing software, or to extract a portion of the video to be used, for example, in a personal webpage or as an attachment to an e-mail.

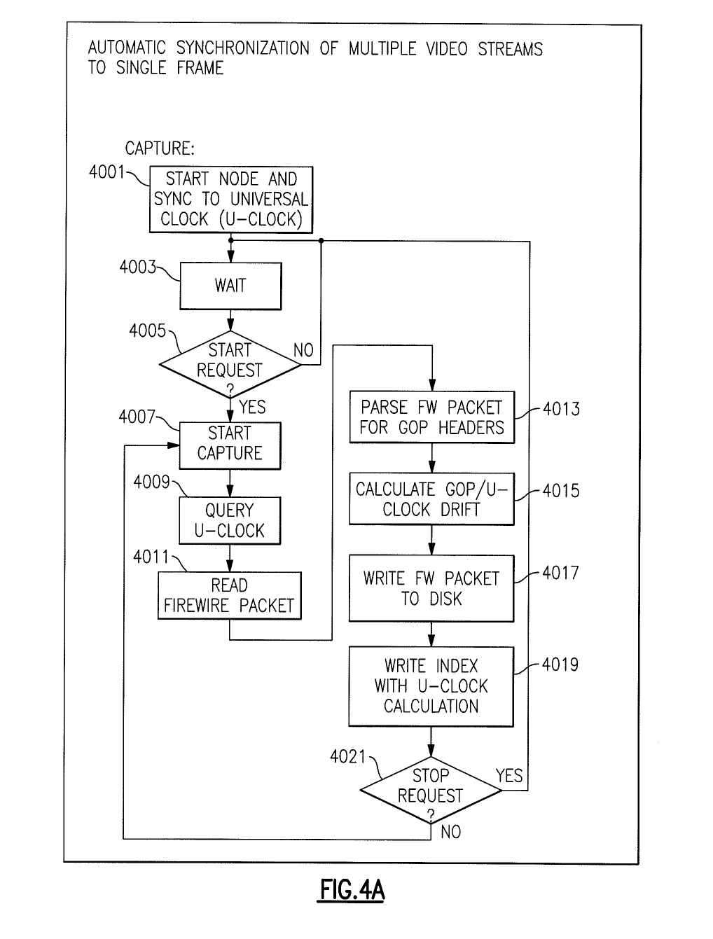

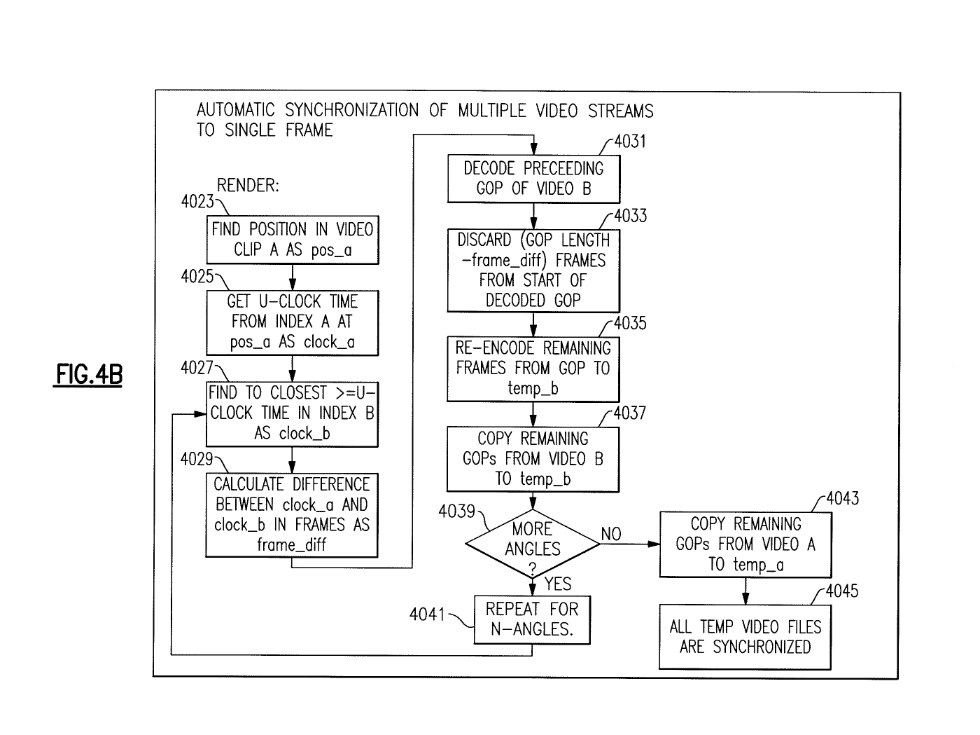

As noted above, in accordance with one or more aspects described herein, video streams from multiple cameras can be automatically synchronized to a single frame. An exemplary logic flow for synchronizing multiple video streams to a single frame is depicted in FIG. 4A-4B, and comprises steps taken at the capture stage (FIG. 4A) and the render stage (FIG. 4B) to provide a synchronized output of multiple video streams.

As seen in FIG. 4A, synchronization of multiple video streams at a capture node begins at step 4001 with a start of the node and sync to a universal clock (U-clock). At step 4003, the capture node waits for a start request. At step 4005 at start request arrives, and the capture node checks to see if the start request applies to it or to another capture node. If the answer at step 4005 is no, it returns to the waiting stage at step 4003 to await the next start request. If the answer at step 4005 is yes, the start request does apply to that particular capture node, then at step 4007, the capture node starts the capture, for example, pursuant to a “syncstart” command from the controller as described above. At step 4009, the capture node queries the U-clock to obtain a start time for the capture. According to digital transport technology known in the art, an MPEG-2 transport stream from any one camera delivers individual frames as part of a group, called a “group of pictures” or GOP. At step 4011, the capture node reads the GOP that is being transferred from the camera, for example, a packet that is being sent over an IEEE 1394 high-speed FIREWIRE connection. At step 4013, the capture node parses the FIREWIRE packet to obtain the headers for the GOP, and at step 4015, the capture node can calculate a difference in time, or a “drift” between a GOP time and the U-clock time for that packet. At step 4017, the capture node can write the FIREWIRE packet to disk and can write an index for that GOP at step 4019, using the U-clock/GOP time calculation made at step 4015. At step 4021, the capture node determines whether there has been a stop capture request sent by the controller, for example, a “syncstop” message as described above. If the answer at step 2021 is “no,” the capture node starts again at step 4007 to await another start request to capture the next group of pictures. If the answer at step 2021 is “yes,” the capture node returns to step 4003 to await another start request.

FIG. 4B shows steps that can be used at the render node to accomplish automatic synchronization of multiple video streams in a single frame in accordance with one or more aspects described herein. As seen in FIG. 4B, at step 4023, render node can find a position in a first video clip, identified as Video Clip A, and identify that position as “pos_a”. At step 4025, render node can get the U-clock time from Index A associated with Video Clip A at pos_a, and can identify that time as “clock_a”. At step 4027, render node can find the time in Index B associated with a second video clip, Video Clip B, that is most closely equal to or greater than the U-clock time, and can identify that time in Video Clip B as “clock_b”. At step 4029, render node can calculate a difference between clock_a and clock_b in terms of a difference in frames between Video Clip A and Video Clip B, and can identify that difference as “frame_diff”.

At step 4031, the GOP of captured Video B that precedes the GOP in the Video Clip B used to calculate the frame_diff is decoded. At step 4033, a number of frames comprising a difference between a length of the GOP decoded at step 4031 and the frame-diff is determined, and that number of frames is discarded from the beginning of the GOP decoded at step 4031. At step 4035, the remaining frames in the GOP of captured Video B is re-encoded and saved to a temporary file “temp_b”. At step 4037, the remaining GOPs from Video B are appended to the end of the temp_b file to create a new temp_b.

At step 4039, the render node determines whether there are more angles, i.e., more video streams, to be synchronized into the single frame. If the answer at step 4039 is no, at step 4043, the GOPs from Video A are copied into a temporary file “temp_a” and at step 4045, the temp video files can be synchronized, for example, using techniques described above with reference to FIGS. 2A-2E. If the answer at step 4039 is yes, in other words, there are additional video streams to be synchronized, the next stream is designated as Video B, and is processed in the same way as the previous Video B stream in steps 4027 through 4037.

In this way, any number of video streams can be automatically synchronized to create a single video frame wherein a user can select the viewing angle presented by any one of the video streams.

In current traditional manual video synchronization, the closest that one video clip can be synchronized to another is within 1/30th of a second by using a snap card known in the art. However, the manual synchronization process requires a skilled video editor, and subject to human errors. In contrast, a method and system for synchronous video capture according to aspects described herein can automatically synchronize multiple video streams within a range of 1/30 to ⅕th of a second. As noted above, in video transport methods known in the art, an MPEG-2 transport stream from any one camera delivers individual frames as part of a group, called a “group of pictures” or GOP. Software used in a system as described herein defaults to the start of the first GOP after the message is received. The GOPs of each video stream may be within ⅕^{th} of a second apart, and may be approaching ⅕^{th} of a second apart between any two discrete video streams at different cameras.

If it should become desirable to synchronize multiple video streams more closely, the system of the present invention can shift one video stream relative to another through the user interface by visually inspecting each stream. As stated previously, the video stream as captured from each camera has approximately 30 frames per second. A user may inspect the frames of the multiple video streams, and select a frame from stream to be “aligned” in time with each other. In this manner, all video streams may be synchronized to within 1/30^{th} of a second, which matches the 30 frames per second at which the video captures the motion. As may be appreciated by those skilled in the art, as the available frames per second of video equipment increases, the individual video streams may be readily synchronized into finer resolutions. The software of the present invention enables a refined synchronization as needed in an intuitive process and may be accomplished by an unskilled user.

In a system according to aspects described above, the video can be available to all video processing operators, independent of the cameras and local computers serving as capture nodes. In this way the capture component of a system in accordance with aspects and features herein can be disassembled without interrupting the ability of the video processors to complete processing and provide the finished product to the consumer. In addition, because the video from the various capture nodes is stored in a central location, the amount of video that can be stored is not limited to what can be stored in a single capture computer but can be increased as necessary to accommodate a larger number of capture nodes, higher video resolutions, or longer video lengths. Use of a central storage repository also allows a plurality of video processors to simultaneously select a desired portion of the video to be displayed, edited, rendered, and burned so that multiple customized video CDs can be created, each having the portion of the video stream that may of interest to a particular user.

In addition, due to the presence of a manager application that can control all of the capturing, editing, rendering, and burning functions described herein, all of these functions can be accomplished automatically based on instructions from the manager and without the need for individual intervention and without the need for the various nodes to be physically located in the same place. All of these aspects enable the present system to be easily scalable, efficient, and cost-effective.

While particular embodiments of the present invention have been described and illustrated, it should be noted that the invention is not limited thereto since modifications may be made by persons skilled in the art. The present application contemplates any and all modifications within the spirit and scope of the underlying invention disclosed and claimed herein.

All patents, patent applications and publications referred to herein are incorporated by reference in their entirety.

### Blah

### Contents

### 1 Introduction . . . 1

1.1 Overview . . . 1

1.2 System Structure . . . 1

### 2 The Nodes . . . 1

2.1 Capture Node . . . 0.1

2.2 Render Node . . . 1

2.3 Manager Node . . . 1

2.4 Burn Node . . . 1

2.5 Controller Node . . . 1

2.6 Tool Node . . . 2

2.7 Node Symbiosis . . . 2

### 3 Common Data Structures . . . 2

3.1 UIDs . . . 2
3.1.1 FID Number . . . 3
3.1.2 Flags . . . 0.5

### 4 File-Formats . . . 6

4.1 .TS File Format . . . 6

4.2 .TSI File Format . . . 6

4.3 .TSM File Format . . . 6

4.4 .FLV File Format . . . 7

4.5 .MP₄ File Format . . . 7

4.6 .FLVM/.MP₄M File Format . . . 7

4.7 .DV File Format . . . 7

4.8 .DVI File Format . . . 7

4.9 .DVM File Format . . . 7

### 5 Networking and Communication . . . 7

5.1 Xml Message Format . . . 7
5.1.1 Request Messages . . . 8
5.1.2 Announcement Messages . . . 0.8
5.1.3 Receipt Messages . . . 0.8

5.2 Tags Defined by the “default” Namespace . . . 9

5.3 “default” Namespace Messages . . . 9
5.3.1 Request Status: . . . 9
5.3.2 Announce Status . . . 0.9
5.3.3 Error Announcement . . . 10
   5.4 “capture” Namespace Messages . . . 10

5.4.1 Default Xml Namespace Definition: . . . 11

5.4.2 Start Recoding: . . . 11

5.4.3 Stop Recording: . . . 11

5.4.4 Synchronized Start: . . . 12

5.4.5 Synchronized Stop: . . . 12

5.4.6 Announce Linked UID . . . 13

5.4.7 Request Configuration: . . . 14

5.4.8 Announce Configuration: . . . 14

5.4.9 Set Configuration: . . . 15

5.4.10 Announce Status: . . . 16

5.4.11 Link Down During Recording Error: . . . 17

5.4.12 Announce Frame: . . . 17

5.5 “controller” Namespace Messages . . . 18

5.5.1 Default Xml Namespace Definition: . . . 18

5.6 “tool” Namespace Messages . . . 18

5.6.1 Default Xml Namespace Definition: . . . 18

5.7 “manager” Namespace Messages . . . 18

5.7.1 Default Xml Namespace Definition: . . . 18

5.7.2 Announce File: . . . 18

5.7.3 Request Data: . . . 19

5.7.4 Reply to Data Request: . . . 0.19

5.7.5 Request Index: . . . 20

5.7.6 Reply to Index Request: . . . 21

5.7.7 Request Library/Files: . . . 21

5.7.8 Update Metadata: . . . 22

5.7.9 Request UID Delete . . . 22

5.8 “burn” Namespace Messages . . . 23

5.8.1 Default Xml Namespace Definition: . . . 23

5.9 “render” Namespace Messages . . . 23

5.9.1 Default Xml Namespace Definition: . . . 23

### 1 Introduction

1.1 Overview

1.2 System Structure

### 2 The Nodes

All the nodes are of equal “importance”. Each node specializes in one particular task. At

### 2.1 Capture Node

Captures video from a camera. One to one relationship between a capture node and a camera. Requires a local manager to serve as its file server so that its output (rendered files) can be accessed by other nodes.

### 2.2 Render Node

Render video clip from source format to deliverable format. Control multiple capture nodes. Requires a local manager to serve as its file server so that its output (rendered files) can be accessed by other nodes.

### 2.3 Manager Node

Primarily acts as a network file system, coordinates the transfer of data across the network to all the other nodes. There is a one to one correlation between physical machines and manager nodes. There must be one, and only one, manager node running on each machine in the system.

### 2.4 Burn Node

Burn rendered video clips to output medium (CD, DVD, HDD). There should be a burn node for each physical DVD-R. CD-R, or external HDD that is connected to the host computer. Does not require a local manager, only needs to be connected via a network to communicate with the other nodes.

### 2.5 Controller Node

User interface to control multiple capture nodes. Does not require a local manager, only needs to be connected via a network to communicate with the other nodes.

### 2.6 Tool Node

Edit video to build and burn orders. Does not require a local manager, only needs to be connected via a network to communicate with the other nodes.

### 2.7 Node Symbiosis

The nodes join together to create symbiotic relationship between each other. A capture node requires there be a controller node to start and stop it. The video tool requires input from the capture node, and outputs data to the burn and render nodes to finish processing. The Burn node takes the rendered video from the Render node and transfers it to a deliverable medium.

### 3 Common Data Structure

3.1 UIDs

The it'sMEdia Suite uses a common file name convention that is maintained across all of the nodes of the system. These unique identification numbers (or UIDs) are generated by the system, and insures that every file being tracked by the suite can be properly identified and accessed.

To insure that these codes are, in fact, unique for every file that can be generated this 64 bit integer is broken down into small fields that attempts to guarantee uniqueness.

3.1.1 FID Number
File Counter

Each node should keep an internal 16 bit counter, every time a new file is generated this counter should be increased. This means that there can be a maximum of 65,335 unique files that belong to a specific node.

Node ID

### Domain

Last byte of the local IP address that the node is running on.

### Type

Describes what the node type is:

| Decimal | Binary | Type |
|---|---|---|
| 0₁₀ | 0000₂ | Invalid/Unknown |
| 1₁₀ | 0001₂ | Capture |
| 2₁₀ | 0010₂ | Tool |
| 3₁₀ | 0011₂ | Controller |
| 4₁₀ | 0100₂ | Burn |
| 5₁₀ | 0101₂ | Render |
| 6₁₀ | 0110₂ | Export |
| 7₁₀-13₂ | 0111₂-1101₂ | Reserved for future use |
| 14₁₀ | 1110₂ | File Server |
| 15₁₀ | 1111₂ | Manager |

### Number

There can be up to 16 nodes of a particular type running on one physical machine/bound to a particular IP address. In practice, it would be rare for more than four nodes of a particular type to run on a physical machines. For example, a capture node requires an available IEEE1394 port. A burn node requires a dedicated CD-R/DVD-R writer to be bound to. And the maximum number of reader node is bound to the available CPUs/cores. A Manager is limited by physical drives/raid controllers. Lastly, only one instance of a Controller node or Tool node can be started on a computer at a time.

3.1.2 Flags

### Format

A 3-bit bit field that describes the of the video that this UID references.

| Decimal | Binary | Format |
|---|---|---|
| 1₁₀ | 001₂ | Original Captured File (TS or DV) |
| 2₁₀ | 010₂ | Rendered for Physical Delivery |
| 4₁₀ | 100₂ | Rendered for Network Delivery |

### Quality

A 5-bit number that describes the quality

| Decimal | Binary | Type |
|---|---|---|
| 1₁₀ | 0 0001₂ | Lowest Quality |
| 2₁₀ | 0 0010₂ | Low Quality |
| 4₁₀ | 0 0100₂ | Normal |
| 8₁₀ | 0 1000₂ | High Quality |
| 16₁₀ | 1 0000₂ | Highest Quality |

Note
When Format = 1₁₀ the quality field is unused and will take the value of 31₁₀ (1 1111₂).

### Terminal Flag/Copy Restriction

A 1-bit flag that when set, the file should not be moved to another manager, nor should another copy of the file be made in its current state. It should be assumed that it is currently being written to or is in its final destination. If this bit is not set, the file is available to be copied or moved to another manager.

### 4 File-Formats

### 4.1 .ts File Format

A series of MPEGs-TS packets. The MPEG₂-TS Packet format is documented in ISO-IEC 13818 Part 1.

4.2 .index File Format

An .INDEX file contains useful information used to efficiently process the raw video data contained in the TS file. This data is used to quickly seek important markers within the file, as well as synchronize video that was captured on different cameras at the exact same time.

4.3 .meta File Format

Meta-data about

### 4.3.1 Metadata for Captured Data

<metadata>

<hierarchy>

<hierarchy.node name=”{string}” value=”{value}”>

...<hierarchy.node ... />

</hierarchy.node>

</hierarchy>
<links>

<uid>{uid}</uid>
...

</links>
<breaks>

<break>{frame_index}</break>
...

</breaks>
<highlights>

<section>

<start>{frame_index}</start>
<stop>{frame_index}</stop>

</section>
...

</highlights>

</metadata>

### 4.3.2 Metadata for Rendered Files

<metadata>

<file>

<uid>{ulong}</uid>
<order.name>{string}</order.name>
<clip.name>{string}</clip.name>
<rendered.at>{datetime : YYYYNNDDhhmmss}</rendered.at>
<exported.at>{datetime : YYYYNNDDhhmmss} |
−1</exported.at>

</file>

</metadata>

### 4.4 .flv File Format

The preferred format for delivery over a low bandwidth network.

4.5 .mp₄ File Format

The preferred format for delivery on a physical distribution medium, optical or magnetic. Also higher quality medium-bandwidth videos can be created using Mpeg₄.

### 4.6 .dv File Format

Standard-definition (SD) video.

### 5 Networking and Communication

### 5.1 Xml Message Format

<message xmlns=”default” xmlns:capture=”capture”

xmlns:manager=”manager” xmlns:tool=”tool”
xmlns:burn=”burn”
xmlns:render=”render” xmlns:controller=”controller”
to=”{endpoint}”
id=”{string}”
node.id=”{nodeid}”
generated.on=”{datetime}”
reply.to=”{endpoint}”
expires.at=”{datetime}”
for.receipt=”{string}”
receipt.required=”{bool}”>

<request></request> | <announcement></announcement> |
<receipt />

</message>

| Attribute | Description | Required |
|---|---|---|
| to | The final destination EndPoint of this | Y |
| | message. Should match the local EndPoint | |
| | of the socket. | |
| id | A message identified unique to the sender. | Y |
| node.id | The unsigned 16 bit node identification for | Y |
| | the sending node. | |
| generated.on | The UNIX time stamp of when message was | N |
| | generated | |
| reply.to | Any replies to this message should be | N |
| | directed to this EndPoint rather than the | |
| | from attribute. If this is not defined, the | |
| | default reply.to EndPoint should be the | |
| | from EndPoint. | |
| expires.at | The UNIX time stamp of when this message | N |
| | should no longer should be concidered valid. | |
| for.receipt | A key that is used as a tracking number to | N |
| | ensure that the message has been received | |
| | and processed. | |
| receipt.required | If set to true the receiving node should | N |
| | reply with a receipt message, using the key | |
| | provided by for.receipt. | |

### 5.1.1 Request Messages

<request type=“{string}”> . . . </request>

### 5.1.2 Announcement Messages

<announcement type=“{string}”> . . . </announcement>

### 5.1.3 Receipt Messages

If a message has a attribute receipt required set to TRUE the the receiving node must reply with the following message to the sender of the message.
<receipt for .id=“{string}” for.receipt=“{string}”/>

If the sending node does not require a confirmation receipt then it should assume that the message not received and it should be retransmitted.

5.2 Tags Defined by the “default” Namespace

Following tags are shared by all other namespaces and are defined in the default namespace of “default”.

These messages should be implemented by all nodes.

### 5.2.1 Request Status

<request type “status”/>

| | |
|---|---|
| Broadcast | Direct |

| Node | In | Out | In | Out |
|---|---|---|---|---|
| Capture Node | X | | X | |
| Controller Node | X | | X | |
| Tool Node | X | | X | |
| Manager | X | | X | |
| Burn Node | X | | X | |
| Render Node | X | | X | |

All nodes must accept incoming status requests and reply with a status announcement.

### 5.2.2 Announce Status

<announcement type=“status”/>

| | |
|---|---|
| Broadcast | Direct |

| Node | In | Out | In | Out |
|---|---|---|---|---|
| Capture Node | | X | | X |
| Controller Node | | X | | X |
| Tool Node | | X | | X |
| Manager | | X | | X |
| Burn Node | | X | | X |
| Render Node | | X | | X |

All nodes most implement a status announcement, even if it is entirely empty as shown above. This tag should be overloaded by a more useful message in the proper namespace.

### 5.2.3 Error Announcement

<announcement type=”error”>

<message>{text}</message>
<severity>[info|warning|low|high|catastrophic]</severity>

</announcement>

| | |
|---|---|
| Broadcast | Direct |

| Node | In | Out | In | Out |
|---|---|---|---|---|
| Capture Node | ? | X | ? | X |
| Controller Node | X | X | X | X |
| Tool Node | X | X | X | X |
| Manager | ? | X | ? | X |
| Burn Node | ? | X | ? | X |
| Render Node | ? | X | ? | X |

5.3 “capture” Namespace Messages

This section describes all of network communication to and from the Capture Node.

### 5.3.1 Xml Namespace Definition

xmlns:capture=“capture”

### 5.3.2 Start Recording

<capture:request type=“start”/>

| | |
|---|---|
| Broadcast | Direct |

| Node | In | Out | In | Out |
|---|---|---|---|---|
| Capture Node | | | • | |
| Controller Node | | | | • |
| Tool Node | | | | |
| Manager | | | | |
| Burn Node | | | | |
| Render Node | | | | |

This message is used by the Controller Node to set the Capture Node into recording mode. If the Capture Node has no “linkes” set in its configuration, this command should open the appropriate files and set its recording status to “busy”. If this camera is “linked”, then the Capture Node should broadcast a syncstart message to start all linked cameras.

### 5.3.3 Stop Recording

<capture:request type=“stop” [auto.increment=“true|false”]/>

| | |
|---|---|
| Broadcast | Direct |

| Node | In | Out | In | Out |
|---|---|---|---|---|
| Capture Node | | | • | |
| Controller Node | | | | • |
| Tool Node | | | | |
| Manager | | | | |
| Burn Node | | | | |
| Render Node | | | | |

This message is used by the Controller Node to stop a recording node. If the camera is not linked, upon receipt of this message, the capture node should close all of the open files, and reset its recording status to “ready”. If the camera is “linked”, then the Capture Node should broadcast a syncstop message to stop all linked cameras.

### 5.3.4 Synchronized Start

<capture:request type=”syncstart”>

<key>{string}</key>
<capture:links>

<nodeid>{nodeid]</nodeid>
...

<capture:links>

</capture:request>

| | |
|---|---|
| Broadcast | Direct |

| Node | In | Out | In | Out |
|---|---|---|---|---|
| Capture Node | • | X | | |
| Controller Node | | | | |
| Tool Node | | | | |
| Manager | | | | |
| Burn Node | | | | |
| Renderd Node | | | | |

The syncstart message signals multiple capture nodes to start recording simultaneously. Upon receipt of this message, a capture node should start recording and announce it current filename to the other capture nodes, using the unique synckey.

### 5.3.5 Synchronized Stop

<capture:request type=”syncstop” [auto.increment=”true|false”]>

<capture:links>

<nodeid>{nodeid]</nodeid>
...

<capture:links>

</capture:request>

| | |
|---|---|
| Broadcast | Direct |

| Node | In | Out | In | Out |
|---|---|---|---|---|
| Capture Node | • | X | | |
| Controller Node | | | | |
| Tool Node | | | | |
| Manager | | | | |
| Burn Node | | | | |
| Render Node | | | | |

This message is used signal multiple capture nodes to stop recording simultaneously.

The “syncid” tag:

The syncid tag is contains a unique key for the current linked capture session. This key is used to coordinate the collection of linked nodes UID numbers. See Section 2.3.6.6 Announce UID

### 5.3.6 Announce Linked UID

<capture:announcement type=”uid”>

<key>{string}</key>
<uid>{uid}</uid>

</capture:announcement>

| | |
|---|---|
| Broadcast | Direct |

| Node | In | Out | In | Out |
|---|---|---|---|---|
| Capture Node | • | • | | |
| Controller Node | | | | |
| Tool Node | | | | |
| Manager | | | | |
| Burn Node | | | | |
| Render Node | | | | |

Upon receipt of a syncstart message, all Capture Nodes started should broadcast an announcement UID, identified by the synckey. Any capture nodes that receive this message should, store the linked UID# in the local copy of the .tsm file

### 5.3.7 Request Configuration

<capture:request type=“configuration”/>

| | |
|---|---|
| Broadcast | Direct |

| Node | In | Out | In | Out |
|---|---|---|---|---|
| Capture Node | • | | • | |
| Controller Node | | • | | • |
| Tool Node | | | | |
| Manager | | | | |
| Burn Node | | | | |
| Render Node | | | | |

### 5.3.8 Announce Configuration

<capture:announcement type=”config”>

<capture:links>

<nodeid>{nodeid}</nodeid>
...

</capture:links>
<capture:grouped.with>

<capture:group.key>{string}</capture:group.key>
<capture:hierarchy>

<capture:hierarchy.node name=”{string}”

value=”{string}”>

...<capture:hierarchy.node ... />
</capture:hierarchy.node>

</capture:hierarchy>

</capture:grouped.with>
</capture:description>{string}</capture:description>
<capture:part>{int}</capture:part>

</capture:announcement>

| | |
|---|---|
| Broadcast | Direct |

| Node | In | Out | In | Out |
|---|---|---|---|---|
| Capture Node | | • | | • |
| Controller Node | • | | • | |
| Tool Node | | | | |
| Manager | | | | |
| Burn Node | | | | |
| Render Node | | | | |

The “links” Tag

The “grouped.with” Tag

The “hierarchy” Tag

The “hierarchy.node” Tag

### 5.3.9 Set Configuration

<capture:request type=”stringfig”>

<capture:links>

<nodeid>{nodeid}</nodeid>
...

</capture:links>
<capture:grouped.with>

<capture:group.key>{string}</capture:group.key>
<capture:hierarchy>

<capture:hierarchy.node name=”{string}”

value=”{string}”>

...<capture:hierarchy.node ... />
</capture:hierarchy.node>

</capture:hierarchy>

</capture:grouped.with>
<capture:description>{string}</capture:description>
<capture:part>{int}</capture:part>

</capture:announcement>

| | |
|---|---|
| Broadcast | Direct |

| Node | In | Out | In | Out |
|---|---|---|---|---|
| Capture Node | | | • | |
| Controller Node | | | | • |
| Tool Node | | | | |
| Manager | | | | |
| Burn Node | | | | |
| Render Node | | | | |

See Section 5.4.10 Announce Configuration.

Note: A Capture Node should not allow its configuration to be updated unless its recording.status equals “ready”. Any message received during that time should not be processed, and an error message should be transmitted to the sender of the message.

### 5.3.10 Announce Status

<capture:announcement type=”status”>

<capture:recording.status>[busy|ready|

unknown]</capture:recording.status>

<capture:link.status>[up|down|unknown]</capture:link.status>

</capture:announcement>

| | |
|---|---|
| Broadcast | Direct |

| Node | In | Out | In | Out |
|---|---|---|---|---|
| Capture Node | | X | | X |
| Controller Node | X | | X | |
| Tool Node | | | | |
| Manager | | | | |
| Burn Node | | | | |
| Render Node | | | | |

### 5.3.11 Link Down During Recording Error

<capture:announcement type=”error”>

<message>The connection to the camera has been lost. Check the

camera status, firewire cable, and connections to try to re-
establish communication with the camera,</message>

<severity>high</severity>

</capture:announcement>

| | |
|---|---|
| Broadcast | Direct |

| Node | In | Out | In | Out |
|---|---|---|---|---|
| Capture Node | X | X | | |
| Controller Node | X | | | |
| Tool Node | X | | | |
| Manager | | | | |
| Burn Node | | | | |
| Render Node | | | | |

If a Capture Node ever detects that its link to the camera has been lost (link.status==down) then the Capture Node should broadcast an error message to alert the user.

### 5.3.12 Announce Frame

<capture:announcement type=”frame”>

<port>{int}</port>
<length>{int}</length>

</capture:announcement>

| | |
|---|---|
| Broadcast | Direct |

| Node | In | Out | In | Out |
|---|---|---|---|---|
| Capture Node | | X | | |
| Controller Node | X | | | |
| Tool Node | | | | |
| Manager | | | | |
| Burn Node | | | | |
| Render Node | | | | |

5.4 “controller” Namespace Messages

This section describes all network communication to and from the Controller Node.

### 5.4.1 Xml Namespace Definition

xmlns:controller=“controller”
   5.5 “tool” Namespace Messages

This section described all of network communication to and from the Tool Node

### 5.5.1 Xml Namespace Definition

xmlns:tool=“tool”
   5.6 “manager” Namespace Messages

This section described all of network communication to and from the Manager Node

### 5.6.1 Xml Namespace Definition

xmlns:manager=“manager”

### 5.6.2 Announce File

<manager:announcement type=“file”>

<fid>{fid}</fid>
<flags>{flags}</flags>
<metadata>

...(See Section 4.3)...

</metadata>

</manager:announcement>

| | |
|---|---|
| Broadcast | Direct |

| Node | In | Out | In | Out |
|---|---|---|---|---|
| Capture Node | | X | | |
| Controller Node | | | | |
| Tool Node | X | | X | |
| Manager | X | X | X | X |
| Burn Node | | | X | |
| Render Node | | X | X | |

### 5.6.3 Announce Removed File

<manager:announcement type=”removed”>

<fid>{fid}</fid>
<flags>{flags}</flags>

</manager:announcement>

| | |
|---|---|
| Broadcast | Direct |

| Node | In | Out | In | Out |
|---|---|---|---|---|
| Capture Node | | X | | |
| Controller Node | | | | |
| Tool Node | X | | X | |
| Manager | X | X | X | X |
| Burn Node | | | X | |
| Render Node | | X | X | |

### 5.6.4 Request Data

<manager:request type=”data”>

<fid>{fid}</fid>
<flags>{flags}</flags>
<offset>{long}</offset>
<length>{long}</length>
<key>{string}</key>

</manager:request>

| | |
|---|---|
| Broadcast | Direct |

| Node | In | Out | In | Out |
|---|---|---|---|---|
| Capture Node | | | | |
| Controller Node | | | | |
| Tool Node | | X | | |
| Manager | X | | X | X |
| Burn Node | | X | | |
| Render Node | | X | | |

### 5.6.5 Reply to Data Request

<manager:announcement type=”data”>

<fid>{fid}</fid>
<flags>{flags}</uflags>
<port>{int}</port>
<length>{long}</length>
<key>{string}</key>

</manager:announcement>

| | |
|---|---|
| Broadcast | Direct |

| Node | In | Out | In | Out |
|---|---|---|---|---|
| Capture Node | | | | |
| Controller Node | | | | |
| Tool Node | | | X | |
| Manager | | | | X |
| Burn Node | | | X | |
| Render Node | | | X | |

### 5.6.6 Request Index

<manager:request type=”index”>

<fid>{fid}</fid>
<flags>{flags}</flags>
<key>{string}</key>

</manager:request>

| | |
|---|---|
| Broadcast | Direct |

| Node | In | Out | In | Out |
|---|---|---|---|---|
| Capture Node | | | | |
| Controller Node | | | | |
| Tool Node | | X | | |
| Manager | X | | | |
| Burn Node | | | | |
| Render Node | | X | | |

### 5.6.7 Reply to Index Request

<manager:announcement type=”index”>

<fid>{fid}</fid>
<flags>{flags}</uflags>
<port>{uint}</port>
<length>{long}</length>
<key>{string}</key>

</manager:announcement>

| | |
|---|---|
| Broadcast | Direct |

| Node | In | Out | In | Out |
|---|---|---|---|---|
| Capture Node | | | | |
| Controller Node | | | | |
| Tool Node | | | X | |
| Manager | | | | X |
| Burn Node | | | | |
| Render Node | | | X | |

### 5.6.8 Request Library/Files

<manager:request type=”files”>

<flags>{flags}</flags> | <flags.mask>{mask}</flags.mask>
[ <fid>{fid}</fid> ]

</manager:request>

| | |
|---|---|
| Broadcast | Direct |

| Node | In | Out | In | Out |
|---|---|---|---|---|
| Capture Node | | | | |
| Controller Node | | | | |
| Tool Node | | X | | |
| Manager | X | X | | |
| Burn Node | | X | | |
| Render Node | | X | | |

### 5.6.9 Update Metadata

<manager:request type=”update-meta”>

<fid>{fid}</fid>
<flags>{flags}</flags>
<metadata>

...(See Section 4.3)...

</metadata>

</manager:request>

| | |
|---|---|
| Broadcast | Direct |

| Node | In | Out | In | Out |
|---|---|---|---|---|
| Capture Node | | | | |
| Controller Node | | | | |
| Tool Node | | X | | |
| Manager | X | | | |
| Burn Node | | | | |
| Render Node | | | | |

All XML Subtree contained by the metadata elements should overwrite the current metadata file for the specified uid number.

### 5.6.10 Request UID Delete

<manager:request type=”delete”>

<fid>{fid}</fid>
<flags>{flags}</flags>

</manager:request>

| | |
|---|---|
| Broadcast | Direct |

| Node | In | Out | In | Out |
|---|---|---|---|---|
| Capture Node | | | | |
| Controller Node | | | | |
| Tool Node | | X | | |
| Manager | X | | | |
| Burn Node | | | | |
| Render Node | | | | |

This message should always set receipt required to true.
5.7 “burn” Namespace Messages

This section describes all of network communication to and from the Burn Node.

### 5.73.1 Xml Namespace Definition

xmlns:burn=“burn”
   5.8 “render” Namespace Messages

This section described all of network communication to and from the Render Node.

### 5.8.1 Xml Namespace Definition

xmlns:controller=“render”
   5.9 “export” Namespace Messages

This section described all of network communication to and from the Render Node.

### 5.9.1 Xml Namespace Definition

xmlns:controller=“render”

### 5.9.2 Render Render:

<render:announcement type=“render”>

<key>{string}</key>
<status>accepted|rejected|failed|completed</status>

</render:announcement>

### 5.9.3 Export Request:

<export:request type=“export”>

<keys>{string}</key>
<uids>

<uid>{ulong}</uid>
. . .

</uids>

</export>

### 5.9.4 Export Status:

<export:announcement type=“status”>

<status>busy|idle</export>
[<key>{string}</key>]
[<export:progress>{0..100}</export:progress>]

</export:announcement>

### 5.9.5 Export Export:

<export:announcement type=”export”>

<key>{string}</key>
<status>accepted|rejected|failed|completed</status>

</expot:announcement>

What is claimed is:

1. A method for processing a plurality of digital video data streams, comprising:
capturing a plurality of digital video data streams to a corresponding plurality of data storage means, each of said digital video data streams comprising a plurality of video clips and including data identifying a content of each of said video clips;
identifying the video clips from at least two of said plurality of digital video data streams having substantially similar content;
synchronizing the identified video clips from at least two of said plurality of digital video data streams to create a single synchronized digital data stream, said single synchronized digital data stream containing the synchronized content from each of said at least two of said plurality of digital video data streams;
extracting said single synchronized digital data stream from said plurality of said digital data streams; and
outputting said extracted single synchronized digital data stream to an output medium.

2. The method for processing a plurality of digital video data streams according to claim 1, further comprising:
creating a central library of said plurality of digital data streams, said library further comprising an index identifying the content of at least one of said plurality of digital data streams;
wherein said at least two digital video data streams to be synchronized are selected from said central library, and further wherein said at least two digital video data streams are synchronized based on information in said index.

3. The method for processing a plurality of digital video data streams according to claim 1, further comprising:
synchronizing said at least two digital video data streams automatically based on the content of each of said at least two digital video data streams.

4. The method for processing a plurality of digital video data streams according to claim 1, further comprising:
editing at least one of said plurality of digital video data streams, said editing being performed directly on said digital video data stream without the creation of an intermediate file between the unedited digital video data stream and the edited digital video data stream.

5. The method for processing a plurality of digital video data streams according to claim 1, wherein said at least two digital video data streams are synchronized with each other within a range of between ⅕^{th} and 1/30^{th} of a second.

6. The method for processing a plurality of digital video data streams according to claim 1, wherein the output medium is one of a CD, a DVD, and a hard disk drive.

7. The method for processing a plurality of digital video data streams according to claim 1, further comprising:
extracting a single frame of said single synchronized digital data stream to produce a still image, said still image comprising content from one of said at least two digital video data streams.

8. The method for processing a plurality of digital video data streams according to claim 6, wherein said still image has a resolution of at least 1280×720 pixels.

9. A method for synchronizing a capture of digital video data from a plurality of linked digital video cameras, comprising:
identifying a capture group comprising a plurality of linked digital video cameras and a corresponding plurality of linked capture nodes, each of said digital video cameras being associated with a capture node on a one-to-one basis;
identifying a plurality of ticks on a universal clock, said plurality of universal clock ticks being used to resolve a time difference between a captured digital image from a first of said plurality of linked digital video cameras in said capture group and a captured digital image from a second of said plurality of linked digital video cameras in said capture group;
sending a start message to a first of said plurality of linked capture nodes, said start message being relayed to each of said linked capture nodes in said capture group, wherein said plurality of linked digital video cameras begins capturing when said start message has been relayed to all of said linked capture nodes in said capture group, a captured output of each of said plurality of linked digital video cameras being stored in a memory in its corresponding capture node; and
sending a stop message to said first of said plurality of linked capture nodes, said stop message being relayed to each of said linked capture nodes in said capture group, wherein said plurality of linked digital video cameras stops capturing when said stop message has been relayed to all of said linked capture nodes in said capture group to create a plurality of linked digital video data streams.

10. The method for synchronizing a capture of digital video data from a plurality of linked digital video cameras according to claim 9, wherein said captured digital video data from said plurality of linked digital video cameras is synchronized to within ⅕^{th} to 1/30^{th} of a second.

11. The method for synchronizing a capture of digital video data from a plurality of linked digital video cameras according to claim 9, wherein said time difference between said captured digital image from said first of said plurality of linked digital video cameras in said capture group and said captured digital image from said second of said plurality of linked digital video cameras in said capture group is resolved within a range of ⅕^{th} to 1/30^{th} of a second.

12. The method for synchronizing a capture of digital video data from a plurality of linked digital video cameras according to claim 9, further comprising creating a single digital video data stream from said synchronized plurality of linked digital video data streams.

13. The method for synchronizing a capture of digital video data from a plurality of digital video cameras according to claim 9, wherein each of said linked digital video data streams is identified by unique identifier.

14. A method of automatically synchronizing a plurality of digital video streams to a single frame, comprising:
receiving information of a baseline time, said baseline time being independent of any of said plurality of digital video streams;
receiving a first digital video stream from a first source, said first digital video stream comprising a first group of pictures, said first group of pictures having first metadata identifying first time information associated with said first group of pictures;
calculating a first time difference between said baseline time and said first time information;
receiving a second digital video stream from a second source, said second digital video stream including a second group of pictures, said second group of pictures having second metadata identifying second time information associated with said second group of pictures;
calculating a second time difference between said first time information and said second time information; and
discarding a portion of said second group of pictures in accordance with said second time difference to synchronize said first and second groups of pictures with said baseline time.

15. The method of automatically synchronizing a plurality of digital video streams according to claim 14, further comprising:
creating a single video data stream from said synchronized first and second groups of pictures.

16. The method of automatically synchronizing a plurality of digital video streams according to claim 14, wherein said first and second groups of pictures are synchronized to within a range of ⅕th to 1/30th of a second.

17. A system for processing a stream of digital video data, comprising:
at least one a capture node, each said at least one capture node being uniquely associated with a corresponding digital video camera, each said capture node being capable of creating an index of content on a digital data stream output by said corresponding digital video camera to said capture node;
a controller node, said controller node being capable of sending and receiving signals said at least one capture node to control a beginning and an end of a capture of digital video data from said corresponding digital video camera;
a manager node, said manager node being capable of receiving the digital video data and the index of content from said at least one capture node, said manager node being further capable of sending and receiving control messages associated with at least one other node in the system;
a tool node, said tool node being capable of identifying a portion of the digital video data from based on said index of content;
a render node, said render node being capable of extracting the portion of the digital video data identified by the tool node; and
a burn node, said burn node being capable of generating an output of the extracted portion of the digital video data on a physical medium.
